(19) United States
(12) Patent Application Publication
(10) Pub. No.: US 2022/0113967 A1
(43) Pub. Date: Apr. 14, 2022

(54) ACCELERATOR FABRIC FOR DISCRETE GRAPHICS

(71) Applicant: Intel Corporation, Santa Clara, CA (US)

(72) Inventors: Abhishek Reddy Pamu, El Dorado Hills, CA (US); Lakshminarayana Pappu, Folsom, CA (US); David J. Harriman, Portland, OR (US); Debra Bernstein, Sudbury, MA (US); Ramadass Nagarajan, Portland, OR (US)

(73) Assignee: Intel Corporation, Santa Clara, CA (US)

(21) Appl. No.: 17/561,197

(22) Filed: Dec. 23, 2021

(51) Int. Cl. G06F 9/30; G06T 1/20; G06T 1/60

(52) U.S. Cl. CPC G06F 9/3016; G06T 1/60; G06T 1/20

(57) ABSTRACT

A system comprising a discrete graphics system-on-chip (SoC) to couple to a host processor unit, the SoC comprising a fabric comprising a handler circuitry to decode a request from a compute engine, the handler circuitry to route the request based on an opcode included in the request, the handler configured to decode the opcode from a set of opcodes for use in requests by the compute engine, wherein the set of opcodes include opcodes corresponding to a first write request type and a first read request type, wherein requests of the first write request type and the first read request type are routed to either the host memory or the graphics memory; and a second write request type and a second read request type, wherein requests of the second write request type and the second request type are to be routed to the sideband network.

### BACKGROUND

A computing system may comprise a discrete graphics system in which a graphics processing unit (GPU) is separate from a central processing unit (CPU). A system utilizing discrete graphics may comprise a memory used by the GPU that is different from a system memory used by the CPU. A system-on-chip (SoC) is an integrated circuit that combines different components, such as those traditionally associated with a processor-based system, into a single chip or, in some applications, within a small number of interconnected chips. In some systems, a GPU may be implemented by a SoC.

### BRIEF DESCRIPTION OF THE DRAWINGS

FIG. 1 illustrates a system comprising an accelerator fabric for a system with discrete graphics in accordance with certain embodiments.

FIG. 2 illustrates a compute request/response handler and a compute engine in accordance with certain embodiments.

FIG. 3 illustrates a memory bridge and memory subsystem in accordance with certain embodiments.

FIG. 4 illustrates a sideband bridge, handler, and network in accordance with certain embodiments.

FIG. 5 illustrates a flow for a request from a compute engine to a memory subsystem in accordance with certain embodiments.

FIG. 6 illustrates a flow for a request from a compute engine to a sideband network in accordance with certain embodiments.

FIG. 7 illustrates a flow for a request from a compute engine to a host memory in accordance with certain embodiments.

FIG. 8 illustrates a flow for a request from a compute engine to an accelerator memory in accordance with certain embodiments.

FIG. 9 illustrates a flow for a request from an input/output (I/O) device to an accelerator memory in accordance with certain embodiments.

FIG. 10 illustrates an example computer system in accordance with certain embodiments.

FIG. 11 illustrates a block diagram of components present in a computing system in accordance with various embodiments.

FIG. 12 illustrates a block diagram of another computing system in accordance with various embodiments.

Like reference numbers and designations in the various drawings indicate like elements.

### DETAILED DESCRIPTION

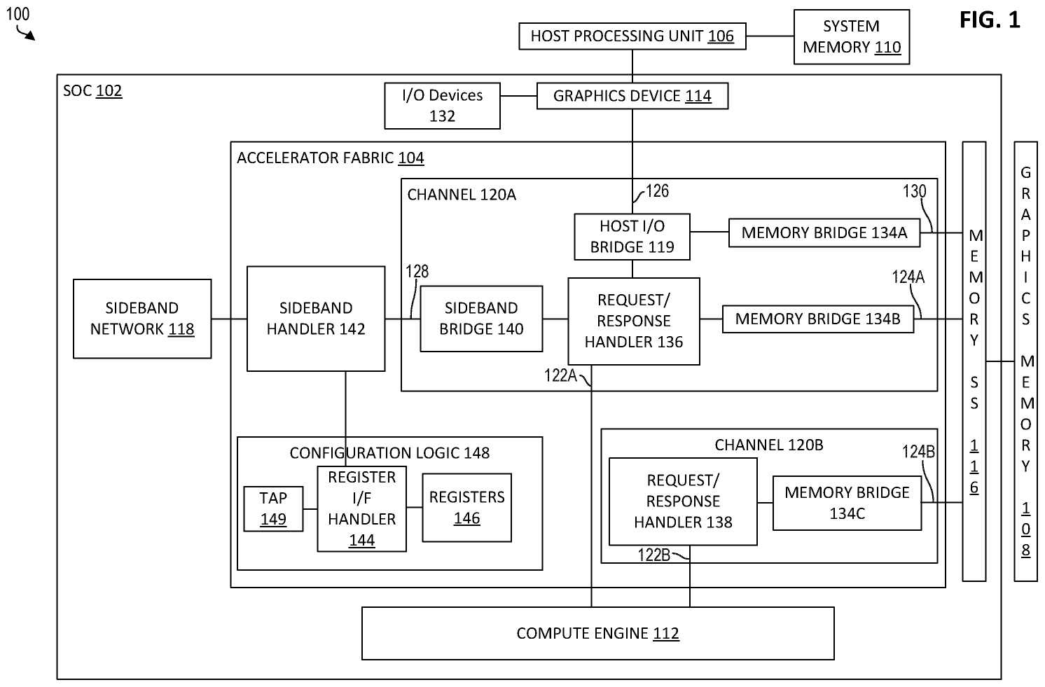

FIG. 1 illustrates a system 100 comprising a discrete graphics system on a chip (SoC) 102 comprising an accelerator fabric 104 in accordance with certain embodiments. The SoC 102 is coupled to a host processing unit 106 (e.g., a central processing unit or other suitable processor, also referred to herein as the host) and a graphics memory 108. The SoC 102 may implement a graphics processing unit (GPU) that is separate from the host processing unit 106 (e.g., on a different chip and/or package). Host processing unit 106 is also coupled to system memory 110. SoC 102 further includes a compute engine 112 (which may also be referred to as a graphics engine or a rendering engine), a graphics device 114, a memory subsystem 116, and a sideband network 118. In various embodiments, the discrete graphics SoC 102 may comprise a single semiconductor chip or multiple semiconductor chips, e.g., in a common package or resident on the same circuit board. For example, the compute engine 112 may be implemented by a first chip and one or more of the other components (or portions thereof) of the SoC may be on one or more additional chips or the illustrated components may be split between multiple chips.

Existing SoC accelerator fabrics for discrete graphics are typically quite bulky and cumbersome. Fabrics may suffer from various drawbacks, such as a high logic gate count, large power consumption, complex protocol semantics, high debug complexity, or expensive implementation, making them unattractive for various systems.

Various embodiments of the present disclosure provide an accelerator fabric 104. In various embodiments, the fabric 104 may be high-speed, power efficient, non-coherent, and/or scalable. The fabric may support transactions between the compute engine 112 and the graphics memory 108, between the compute engine 112 and the host memory (e.g., system memory 110), between agents on the SoC (e.g., SoC agents coupled to sideband network 118) or coupled to (e.g., I/O devices) and the graphics memory 108, between the compute engine 112 and SoC agents coupled to the sideband network 118, and/or between the host (e.g., host processing unit 106) and the graphics memory 108.

The fabric 104 may support a limit set of optimized opcodes for the compute engine 112. These opcodes allow the compute engine to communicate with the other device components of the SoC 102 (e.g., components coupled to the sideband network 118), the host's memory (e.g., system memory 110), and the local memory of the SoC (e.g., graphics memory 108). In one example, the opcode set used by the compute engine 112 for communications sent via the fabric 104 includes opcodes for five instructions: a 64-byte full cache-line write (referred to herein as “NSWF”) used to write to the graphics memory 108 or the system memory 110, a 64-byte partial write (referred to herein as “NSW”) used to write to the graphics memory 108 or the system memory 110, a 64-byte read request (referred to herein as “NSRDF”) used to read from the graphics memory 108 or system memory 110, a region read request (referred to herein as “PORTIN”) to write to memory (e.g., registers) of a device coupled to the sideband network 118, and a register write request (referred to herein as “PORTOUT”) to read from a memory of a device coupled to the sideband network 118. Various embodiments may include a host I/O bridge 119 that communicates between the host and the graphics memory 108 as well as communicates transactions sent by the compute engine for the system memory 110 to the host.

Various embodiments may provide a fabric 104 that provides one or more technical advantages, such as occupying a relatively small amount of chip area, low power utilization, simple protocol semantics, or low debug complexity relative to previous fabrics for discrete graphics systems.

FIG. 1 presents a high-level overview of an accelerator fabric 104. The basic building block of the accelerator fabric 104 is referred to as a channel 120 (e.g., 120A, 120B). Each channel has a link to the compute engine 112, referred to herein as a compute link 122 (e.g., 122A, 122B). Each channel also has a link to the memory subsystem 116, referred to herein as a local memory link 124 (e.g., 124A, 124B) for local memory transactions (e.g., memory transactions originating at the SoC 102). In some embodiments, one or more of the channels may have one or more other links, such as a primary fabric link 126 for transactions involving the host or an I/O device 132, a sideband link 128 for sideband (e.g., funnyIO) transactions, and a host and I/O memory link 130 for host and I/O device transactions with the graphics memory 108. Each channel 120 is modular and self-consistent and thus the accelerator fabric 104 may be scaled based on the memory configuration and SoC flows (e.g., additional channels 120 may be added to the accelerator fabric 104). In the example depicted, the fabric 104 includes two channels 120A and 120B. Channel 120A has all five links described above (e.g., 122A, 124A, 126, 128, and 130), whereas channel 120B only has only the default links (e.g., 122B, 124B).

Compute engine 112 may perform any suitable compute operations related to the graphics functionality of the SoC 102, such as rendering operations (e.g., shading, lighting, texturing, etc.). The compute engine 112 may also be referred to as a graphics engine or a rendering engine. In various embodiments, compute engine 112 may comprise a plurality of modular execution unit (EU) slices to process data.

The memory subsystem 116 may couple to any number of memory links (e.g., 124, 130) of channels 120. A memory subsystem may include any number of memory controllers and memory PHYs connected to the graphics memory 108. In some embodiments, a particular memory controller and PHY may be coupled to respective memory device of the graphics memory 108.

The graphics memory 108 may comprise any suitable type of memory, such as dual data rate (DDR) memory such as low-power DDR (LPDDR) or graphics DDR (GDDR) (or other suitable memory, including any type of memory described herein). In some embodiments, the graphics memory 108 is permanently or removably coupled to the SoC 102.

The graphics device 114 may be responsible for interfacing the SoC 102 with the host. For example, the graphics device 114 may sequence host transactions and may ensure message ordering (e.g., PCIe ordering). Such host transactions may include, e.g., configuration transactions, memory transactions, or I/O transactions.

Host I/O bridge 119 may handle transactions between the host or an I/O device and the graphics memory 108 as well as transactions between the compute engine 112 and the host memory (e.g., system memory 110). Bridge 119 may perform operations such as link management of the primary fabric link 126, protocol conversion, ordering of messages (e.g., enforce PCIe ordering), buffering of messages through request and response (Rsp) FIFOs until the messages are ready to be sent towards their destination, write fragmentation and response merging, and clock crossing (e.g., the bridge 119 may convert clocking of signals between a first clock domain used by the compute request/response handler and/or the memory bridge and a second clock domain used by the primary fabric (e.g., including the primary fabric link 126 and graphics device 114)).

As used herein, link management for a particular link may include any one or more of the following functions: initializing a link, providing power management for the link (e.g., powering down the link when it is not in use), credit management (e.g., track the number of transactions pending and/or in flight), bandwidth management (e.g., applying backpressure), clock management (e.g., provision of a clock for the link), or other suitable link management operations.

Protocol conversion performed by the bridge 119 may include converting communications (e.g., read and write requests such as NSWF, NSW, and NsRdF requests) received from the compute engine 112 from a first protocol (referred to herein as the compute protocol) utilized by the compute engine 112 (e.g., an in-die interface (IDI), PCIe, Cache Coherent Interconnect for Accelerators (CCIX), Compute Express Link (CXL), or other suitable protocol) into a second protocol (referred to herein as the primary fabric protocol) for the primary fabric link 126 (e.g., a PCIe, integrated on-chip system fabric (IOSF), NVLink, Ultra Path Interconnect (UPI), or other suitable protocol) and then forwarding the converted communications to the graphics device 114 (e.g., towards the host). Similarly, the bridge 119 may receive communications (e.g., completions) from the host (e.g., via graphics device 114) responsive to memory requests sent to the host by the compute engine 112 and convert them from the primary fabric protocol to the protocol of the compute engine 112 before sending the communications to the compute request/response handler 136 on their way to the compute engine 112.

Protocol conversion performed by the bridge may also include converting communications received from the graphics device 114 (which may be, e.g., from the host processing unit 106 or an I/O device 132) from the primary fabric protocol into a second protocol (e.g., the compute protocol) for the memory bridge 134A and vice versa (for communications from the memory bridge 134A towards the host or an I/O device 132).

The bridge 119 may also maintain message ordering restrictions associated with the protocol of messages received from the graphics device 114. For example, this may include preventing certain messages from passing other messages. For example, a posted request may not be allowed to pass a previous posted request, but may be able to pass previous non-posted read requests or previous completions. As another example, a non-posted request may not be allowed to pass a previous posted request, but may or may not be able to pass previous non-posted read requests or completion requests (depending on the implementation). As yet another example, a completion request may not be allowed to pass a previous posted request, may be allowed to pass a previous non-posted read request, and may or may not be allowed to pass a previous completion (depending on the implementation). In various embodiments, strict vs. relaxed ordering may be configurable for the bridge 119. The ordering of transactions may help avoid memory hazards (e.g., write after write, write after read, etc.).

Bridge 119 may also perform write fragmentation and response merging. For example, the compute protocol and the protocol (referred to herein as the memory protocol) used to communicate with the memory subsystem 116 may support a random byte enable in a particular size (e.g., 64 byte) boundary whereas the primary fabric protocol (e.g., PCIe) may only support random byte enables in a different size (e.g., 8 byte) boundary. In order to bridge the difference between the two protocols, writes with random byte enables from the compute engine 112 may be split into eight separate writes on the primary fabric link 126 and the corresponding eight responses from the primary fabric link may be merged into a single response sent to the compute engine.

As alluded to above, host I/O bridge 119 may receive read and write instructions from the host. The instructions may include product segment specific efficient host opcodes for the host to communicate to the graphics memory 108. For example, such instructions may include, e.g., opcodes corresponding to a read with 32-bit addressing (MRd32), a read with 64-bit addressing (MRd64), a write with 32-bit addressing (MWr32), or a write with 64-bit addressing (MWr64).

The host I/O bridge 119 may streamline the traffic from the host to the graphics memory 108 (as in other SoCs not including a host I/O bridge, the traffic from the host may pass through the compute engine before being sent to the graphics memory). The bridge 119 may handle partial writes and reads as well as decode transactions from the host (e.g., to determine whether the transaction should go to the graphics memory 108 or the compute engine 112).

In some embodiments, a host I/O bridge 119 (and the compute request/response handler) may include virtual-to-physical address mappings for the graphics memory 108 (in order to translate virtual addresses supplied by the host or I/O devices 132 into physical addresses of the graphics memory 108). In some embodiments, the host I/O bridge 119 may also implement at least a portion of an input-output memory management unit (IOMMU) transaction to translate virtual addresses provided by the compute engine to physical addresses of the system memory 110.

In various embodiments, the host I/O bridge 119 may also include logic to implement security on transactions (e.g., to determine whether a transaction is allowed and to block the transaction if it is not allowed). For example, the host I/O bridge 119 may filter out transactions based on security attributes and return zero completion or unsupported request messages if the security attributes are not correct or pass the transactions on to the memory bridge 134A or compute request/response handler 136 if the security check passes.

Memory bridges 134 (e.g., 134A, 134B, 134C) may receive requests from respective entities (e.g., 119, 136, 138) and pass the requests on to a respective link (e.g., 130, 124A, 124B) to the memory subsystem 116. Memory bridges 134 may also receive responses on their respective links and forward the responses back to the respective entities towards their destinations.

A memory bridge 134 may perform link management of its respective link (e.g., 130, 124A, 124B) to the memory subsystem 116. A memory bridge 134 may also provide protocol conversion for received messages. For example, one or more of the memory bridges 134 may receive requests in the compute protocol and translate the requests into the memory protocol (e.g., converged memory fabric (CMF), advanced eXtensible interface (AXI), or other suitable memory protocol) before sending to the memory subsystem 116. Similarly, the memory bridges 134 may receive responses in the memory protocol and translate the responses to the compute protocol before transmitting the responses.

A memory bridge 134 may also include request and response FIFOs as well as arbitration logic to control the transmission of requests and responses.

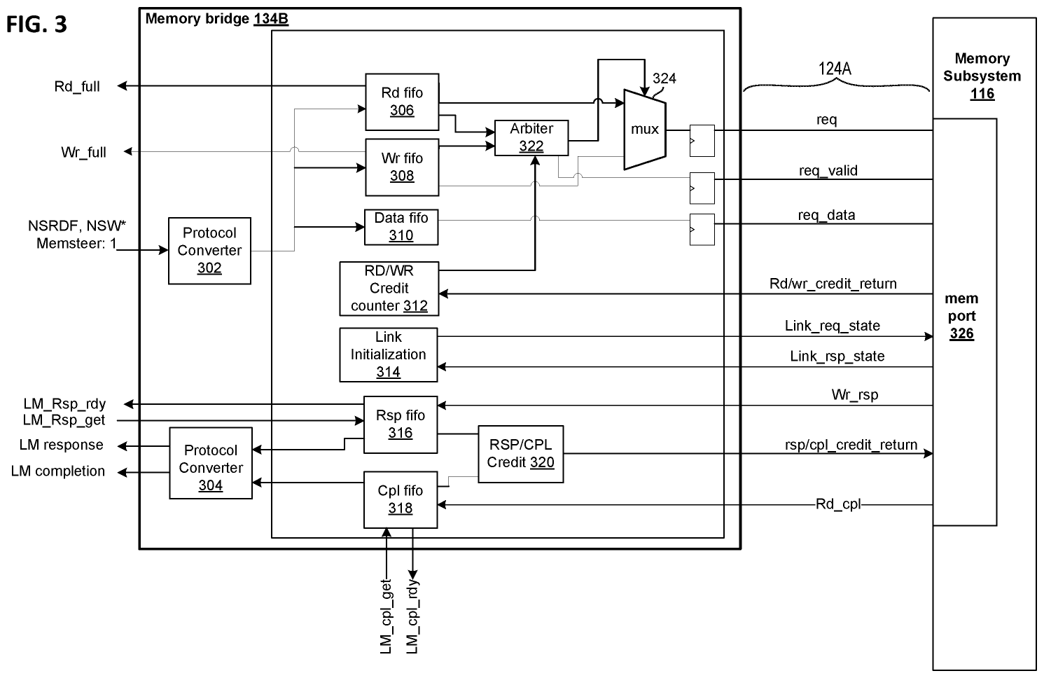

Memory bridge 134B will be described in more detail below in connection with FIG. 3. The other memory bridges 134A, 134C may include any suitable characteristics of memory bridge 134B or may differ in any suitable manner. For example, memory bridge 134A may include one or more buffers configured for traffic between the host and the graphics memory 108 whereas memory bridges 134B and 134C include buffers configured for traffic between the compute engine 112 and the graphics memory 108.

Sideband network 118 may comprise an auxiliary low speed network connecting various components of the SoC 102. The sideband network 118 may be reached by the compute engine 112 through the compute request/response handler 136, sideband bridge 140, and sideband handler 142. The compute engine 112 may issue transactions to access the register space of various components coupled to the sideband network 118 (e.g., to configure such components).

Any suitable components of the SoC 102 may be coupled to the sideband network 118 and reachable by the compute engine 112. Various examples of SoC agents (although the connectivity to such is not shown) may include debug logic, graphics device 114, a serial peripheral interface (SPI) controller, a flash device controller, a type-C port (e.g., for a virtual reality (VR) subsystem), a display controller, an audio controller, a telemetry controller, a power management controller, a security module (e.g., CSC security module), or other suitable circuitry.

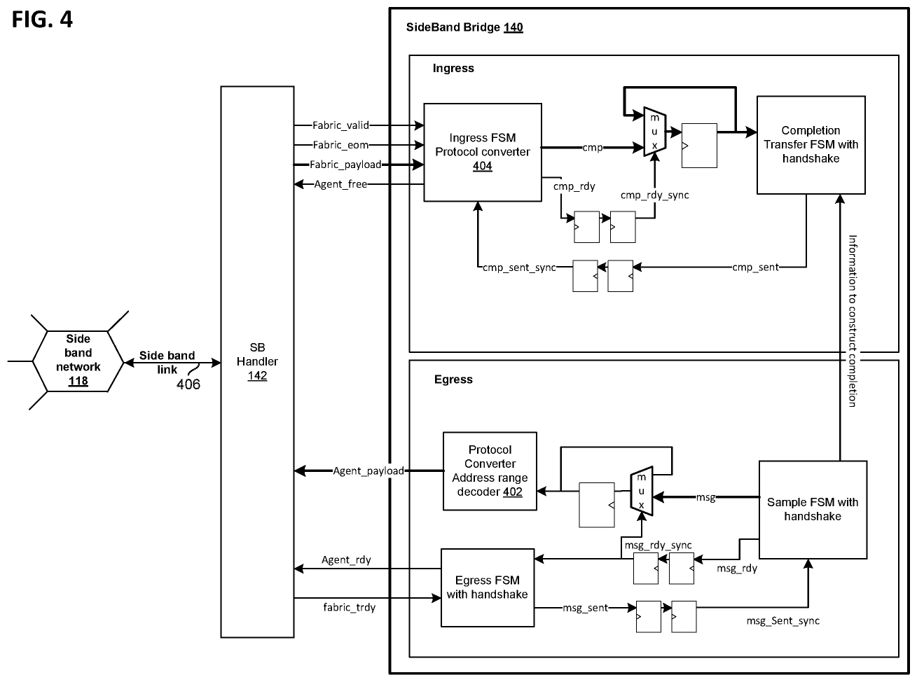

Sideband handler 142 may perform link management and protocol handling operations for communications with the sideband network 118 and the configuration logic 148. The sideband bridge 140 may decode addresses provide by the compute engine into physical addresses of the sideband network 118 (e.g., register addresses for the targeted components). The sideband bridge 140 may also perform protocol conversion to convert messages sent by the compute engine in the compute protocol to a protocol (referred to herein as a sideband protocol) used within the sideband network (e.g., advanced peripheral bus (APB), IOSF-SB, or other suitable protocol). The sideband bridge may also convert clocking of signals between a first clock domain used by the compute request/response handler 136 and a second clock domain used by the sideband handler 142, register I/F handler 144, and registers 146. The sideband bridge 140 is described in more detail in connection with FIG. 4.

In addition to the channels 120, the accelerator fabric 104 may include registers 146 for configuration, status, and performance statistics. These registers may be accessible through the sideband handler as well as through a test access point (TAP) 149. TAP may comprise circuitry (e.g., a state machine and shift registers) to facilitate testing of the SoC 102. For example, the fabric 104 may support trace packetization and transfer to debug agent via a debug fabric (which may be coupled to registers 146). This may provide special debug features accessible through a secure mechanism to manually inject transactions to the host or graphics memory 108 (thus the transactions appear as if they are coming, e.g., from the host or the compute engine 112). In various embodiments, TAP 149 may be used during testing to form the transactions (e.g., read and write commands for the graphics memory 108 or system memory 110) and to provide the results to an external monitoring system.

As alluded to above, various components within the SoC may be part of different clock domains, running at different frequencies. Although the clock domains of the SoC 102 may be arranged in any suitable manner, in one example, circuitry of the compute engine 112, request response handlers 136 and 138, memory bridges 134, host I/O bridge 119, sideband bridge 140, and memory subsystem 116 are in a first clock domain (high speed clock); other circuitry of the host I/O bridge 119 and the graphics device 114 are in a second clock domain (a primary fabric clock); other circuitry of the sideband bridge 140, the sideband handler 142, register I/F handler 144, and registers 146 are in a third clock domain (sideband clock); circuitry of TAP 149 is in a fourth clock domain (TAP clock), and circuitry of the debug fabric may be in a fifth clock domain (debug fabric clock).

Although various FIGs. herein may illustrate components that are compatible with particular protocols (e.g., PCIe, IOSF, PSF, etc.), the embodiments of the present disclosure contemplate components using any other suitable communication protocols. Thus, a particular component that is labeled with a particular protocol may be understood to be a broader disclosure of that type of component.

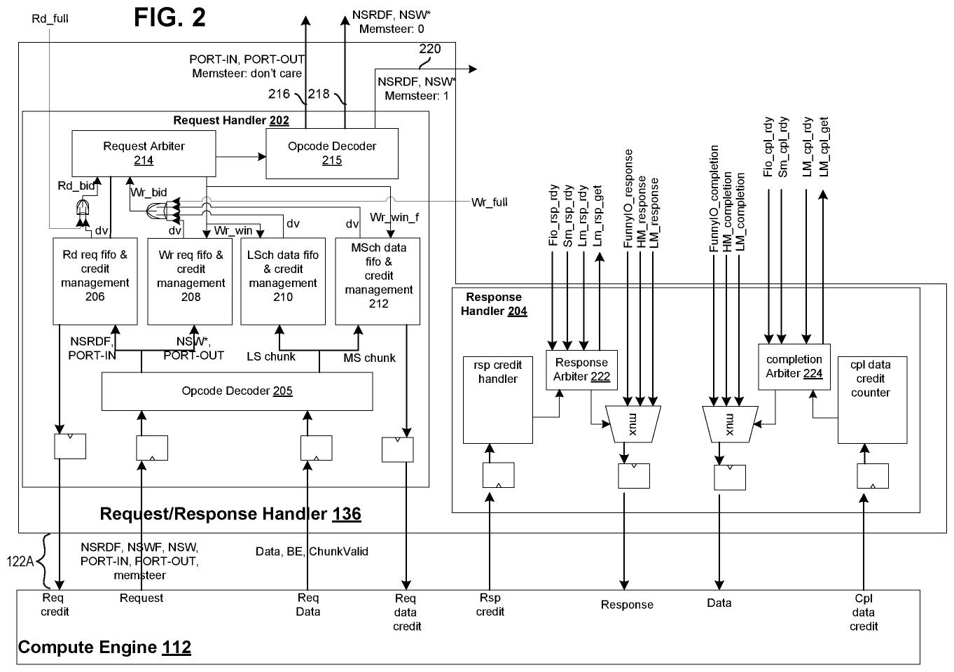

FIG. 2 illustrates compute request/response handler 136 and compute engine 112 in accordance with certain embodiments. Any of the components of handler 136 may also be present in handler 138, although handler 138 could be implemented such that it doesn't have to steer traffic to and from the host I/O bridge 119 or the sideband bridge 140 (e.g., compute engine 112 may only use channel 120B for transactions with the graphics memory 108).

Compute engine 112 includes signal channels for a variety of signals. The signal channels may be coupled to a link (e.g., 122A) to the handler 136. In the embodiment depicted, the signal channels include request credit (req credit), request, request data (req data), request data credit (req data credit), response credit (rsp credit), response, data, and completion data credit. In embodiments comprising multiple channels 120, the compute engine 112 may comprise a set of signal channels (e.g., similar to the set shown in FIG. 2) for each channel 120.

Handler 136 includes a request handler 202 and a response handler 204. The request handler 202 receives requests from the compute engine 112 and forwards them to the appropriate entity. In one embodiment, the fabric 104 supports a set of five opcodes (as described above) for requests by the compute engine 112, although other embodiments contemplate different instruction sets.

NSWF may signify a 64-byte full cache-line write, wherein all write enables are set to “1”. This transaction may be issued to the graphics memory 108 or the host. NSW may signify a 64-byte partial write (e.g., with partial write enables on a per-byte granularity). This transaction may also be issued to the graphics memory 108 or the host. NSRDF may signify a 64-byte read request and may also be issued to the graphics memory 108 or the host. PORTIN may signify a read request for the register space of the sideband network 118 and PORTOUT may signify a write request for the register space for the sideband network 118. In other embodiments, the various read and write commands may specify reads or writes of a different size (e.g., 32-bytes, 128-bytes, etc.).

The request may be sent to the sideband bridge 140 if the request is PORTIN or PORTOUT; to the host I/O bridge 119 if the request is NSW, NSWF (where either of these requests is denoted in the FIG. as NSW*), or NSRDF and the address of the request corresponds to the host; or to the memory bridge 134B if the request is NSW, NSWF, or NSRDF and the address of the request corresponds to the graphics memory 108.

The Request signal channel may specify an opcode corresponding to the desired read command (e.g., NSRDF, PORTIN) or write command (NSW, NSWF, PORTOUT). The Req Data signal channel may comprise data if the request is a write request, such as NSW, NSWF, or PORTOUT. The Req credit signal channel is used to transport a signal indicating that an additional request credit is available (e.g., the compute engine 112 may only be able to send a certain number of requests until a credit is received, indicating that an additional request may be sent). Similarly, the Req data credit signal channel is used to transport a signal indicating that an additional request data credit is available. The requests decoded by opcode decoder 205 may be stored in respective FIFOs. For example, read requests (e.g., NSRDF and PORTIN) may be stored in Rd req fifo 206 and write requests (e.g., NSW, NSWF, PORTOUT) may be stored in Wr req fifo 208.

The Req data may be decoded by opcode decoder 205 and stored in one or more FIFOs. In the embodiment depicted, the Req data signal channel may be used to transport either a least significant (LS) chunk of the request data or a most significant (MS) chunk. For example, each chunk may include 32 bytes of a 64 byte request (although other sizes are contemplated herein). The data width of the Req data may be 32 bytes and hence the data associated with a request is sent in 2 cycles (in some embodiments, the data does not have to be sent in consecutive cycles). The LS chunk is stored in FIFO 210 and the MS chunk is stored in FIFO 212. The FIFOs 206, 208, 210, and 212 may have associated credit management logic which initializes credits at the start of operation and return credits upon draining a request from the FIFOs.

Request arbiter 214 may control the flow of requests (and associated request data) sent out by the request handler. Although any suitable arbitration policy may be used, in one embodiment reads and writes are arbitrated using a round robin policy. Write is available for arbitration only when both the haves of 64B data are available. Once a request passes the arbiter, it is passed to opcode decoder 215, which routes the request based on its opcode as well as a memsteer value (where a value of 1 indicates the transaction is destined for the graphics memory 108 and a value of 0 indicates the transaction is destined for the host). If the opcode indicates a PORTIN or a PORTOUT, the request is routed to the sideband bridge via link 216 (regardless of the value of memsteer). If the opcode indicates a NSRDF, NSW, or NSWF then it is routed to the memory bridge 134B via link 220 if memsteer is set or to host I/O bridge 119 via link 218 if memsteer is not set.

The compute engine may track memory ranges corresponding to the host memory and the graphics memory. When the compute engine generates a memory request, the address may be checked against the ranges and the memsteer value of the request may be set accordingly by the compute engine 112.

The response handler 204 receives responses (for write commands) and completions with data (for read commands) from the graphics memory 108, host memory (e.g., system memory 110), and sideband network 118. The responses and completions are arbitrated employing any suitable arbitration policy. In one embodiment, the responses and completions are arbitrated by arbiters 222 and 224 using a weighted round robin policy, wherein the graphics memory 108 has the highest weight, the host has the next highest weight, and the sideband network 118 has the lowest weight. After arbitration, the responses and completions are sent to the appropriate entity (e.g., compute engine 112 in this scenario), with completions being sent on the Data signal channel. Credit management logic of the response handler 204 keeps track of available resources in compute engine FIFOs in order to prevent overwriting the previous data (and compute engine 112 may sent Rsp credit and Cpl data credit signals when responses or completions have been drained).

The handler 136 may comprise an unordered fabric segment. No ordering is guaranteed, and thus the requestor (e.g., compute engine 112) is responsible to avoid same address conflicts.

FIG. 3 illustrates a memory bridge 134B and memory subsystem 116 in accordance with certain embodiments. In the embodiment depicted, memory bridge 134B includes protocol converters 302 and 304, read FIFO 306, write FIFO 308, data FIFO 310, read/write credit counter 312, link initialization logic 314, response FIFO 316, completion FIFO 318, response completion credit logic 320, arbiter 322, and multiplexor 324.

Protocol converter 302 may convert the protocol (e.g., compute protocol) of an incoming request to a protocol (e.g., memory protocol) used by the memory subsystem 116. Conversely, protocol converter 304 may convert the protocol (e.g., memory protocol) of an outgoing completion or response to a protocol (e.g., compute protocol) used by the compute engine 112.

On the request path, read FIFO 306 may store read requests (e.g., NSRDF requests), write FIFO 308 may store write requests (e.g., NSW or NSWF requests), and data FIFO 310 may store data associated with the requests (e.g., write data). The requests may be arbitrated by arbiter 322 (e.g., using round robin or other suitable policy) and then passed through multiplexor 324 along with the request data (e.g., write data) when the request is selected by the arbiter 322. If no credit is available, the credit counter 312 may prevent the arbiter 322 from sending an additional request until a credit is returned from the memory subsystem 116.

On the return path, responses (e.g., indicating that a write is complete) and completions (e.g., including read data) are received from the memory subsystem 116. Since responses and completions are separate channels in both memory link 124A and compute link 122A, no arbitration is required. The responses and completions are translated from the memory protocol to the compute protocol by protocol converter 304 and then forwarded to the compute engine 112.

Memory link 124A between the bridge 134B and a memory port 326 of the memory subsystem 116 includes request, request data (req_data), response (Wr_rsp), and completion (Rd_cpl) channels (similar to the compute link 122A although the fields and their definitions may be different between the compute protocol and the memory protocol). The memory link 124A also includes a request valid (req_valid), read/write credit return (rd/wr_credit_return), link request state (link_req_state), link response state (link_rsp_state), and response/completion_credit_return (rsp/cpl_credit_return) signals. The various credit signals and logic may be used in a similar fashion to other credit signals described herein (e.g., to ensure that storage elements on the memory bridge 134B and memory port 326 do not overflow).

Memory bridge 134B also has link initialization logic 314 to setup the memory link 124A and exchange credits with the memory subsystem 116. The memory bridge 134B may also be an unordered fabric segment.

FIG. 4 illustrates a sideband bridge 140, sideband handler 142, and sideband network 118 in accordance with certain embodiments. As alluded to above, the compute engine 112 may access register space of SoC agents coupled to the sideband network 118. In some embodiments, this may be done through funnyIO transactions. The sideband bridge 140 receives the funnyIO transactions (or other sideband transactions) and routes them to the various SoC agents on the sideband network 118, receives the completions from the SoC agents, and sends them to the compute request/response handler 136 for return to the compute engine 112. The sideband bridge 140 comprises address decoding and mapping information to compute the destination SoC agent and the register offset details.

The sideband bridge 140 is responsible to extract fields of a packet from the compute engine 112 and form a corresponding packet for the sideband network 118 (and vice versa for packets going back to compute engine 112 from the sideband network). Thus, on the egress side, the sideband bridge 140 may queue requests and then translate the requests from the compute protocol to the sideband protocol using the protocol converter and address range decoder 402. Similarly, on the ingress side, the ingress finite state machine and protocol converter 404 may translate responses and completions from the sideband network back into the compute protocol for consumption by compute engine 112.

The sideband bridge 140 may include clock crosssing logic to transfer data between a highspeed clock domain and a sideband clock domain. The sideband bridge 140 may also include link management logic to setup and manage the sideband link 406.

FunnyIO transactions generally require strict ordering and since these are not high bandwidth transactions, in some embodiments, ordering may be ensured by limiting the number of outstanding transactions to one.

As described above, the sideband handler 142 may perform link management and protocol handling operations for communications with the sideband network 118 and the configuration logic 148. The sideband handler 142 may also provide an interface between the sideband network 118 and the sideband bridge 140.

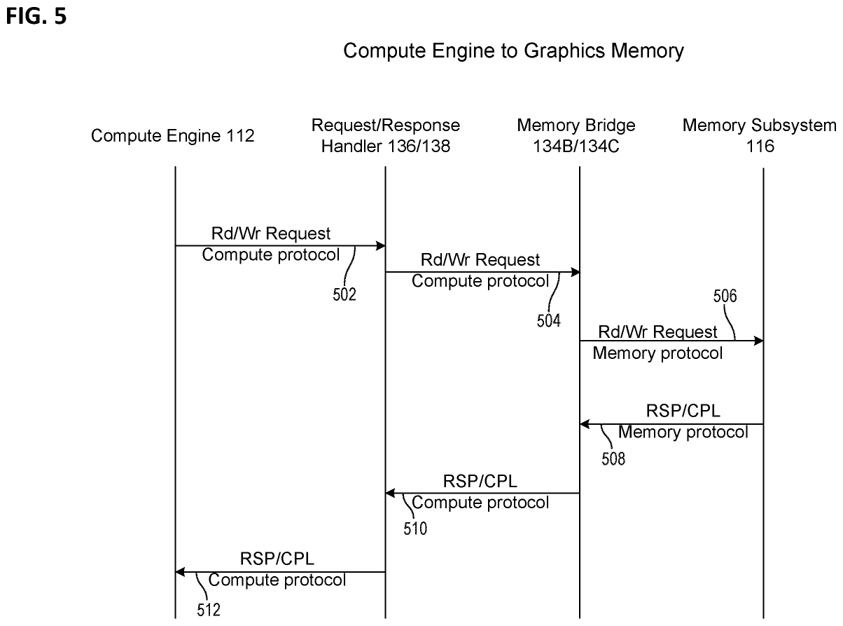

FIG. 5 illustrates a flow for a request from a compute engine 112 to a graphics memory 108 in accordance with certain embodiments. The flow may be the same whether the request is sent to request/response handler 136 of channel 120A or request/response handler 138 of channel 120B. At 502, a read (e.g., NSRDF) or write (e.g., NSW, NSWF) request is sent in the compute protocol from the compute engine 112 to the request/response handler 136 (or 138). At 504, the request is forwarded to the memory bridge 134B (or 134C). The request is translated into the memory protocol and then sent to the memory subsystem 116. The memory subsystem responds to the memory bridge 134B (or 134C) with a response or completion in the memory protocol at 508. The memory bridge 134B (or 134C) translates the response or completion into the compute protocol and then sends it to the request/response handler 136 (or 138) at 510. At 512, the response or completion is sent to the compute engine 112.

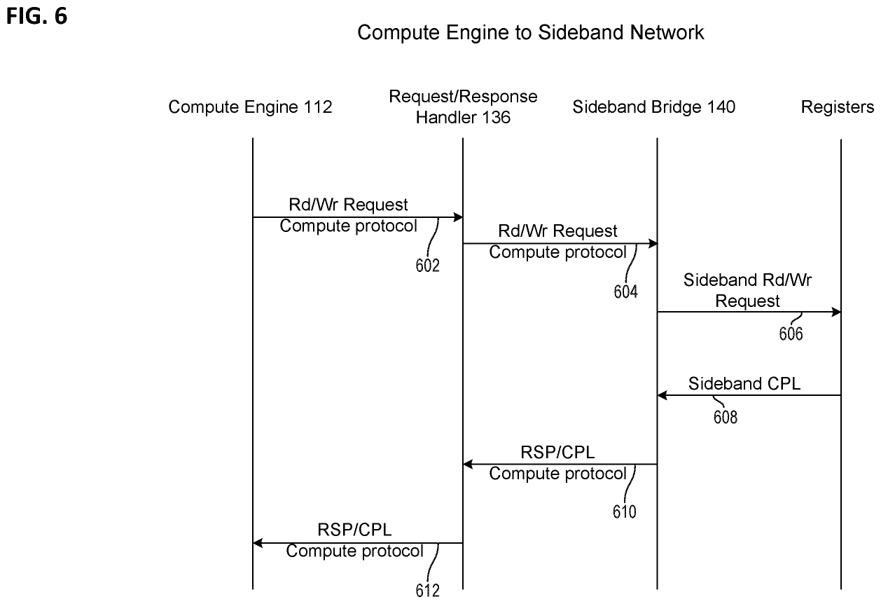

FIG. 6 illustrates a flow for a request from a compute engine 112 to a sideband network in accordance with certain embodiments. At 602, a read (e.g., PORTIN) or write (e.g., PORTOUT) in the compute protocol is sent from the compute engine 112 to the request/response handler 136. At 604, the request is forwarded to the sideband bridge 140. The sideband bridge 140 may translate the request into a protocol used by the sideband network. The request is then forwarded to the register(s) (e.g., of an SoC agent) targeted by the request at 606. At 608, a sideband completion is sent from the registers to the sideband bridge 140. The sideband bridge 140 may translate the sideband completion into a response or completion in the compute protocol. This is then sent to the request/response handler 136 at 610. The response or completion is then sent to the compute engine 112.

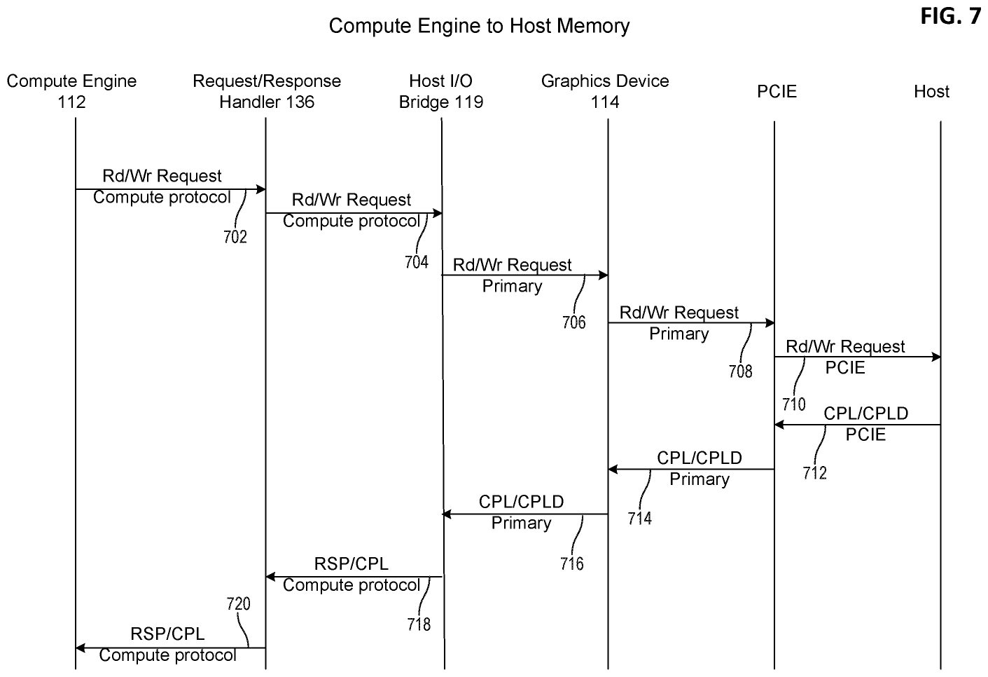

FIG. 7 illustrates a flow for a request from a compute engine 112 to a host memory in accordance with certain embodiments. At 702, the compute engine sends a read (e.g., NSRDF) or write (e.g., NSW, NSWF) request in the compute protocol to request/response handler 136. The request is forwarded to the host I/O bridge 119 at 704. The bridge 119 translates the request into a primary fabric protocol and then sends the request to the graphics device 114 at 706. The graphics device 114 then forwards the request to a PCIe communication element at 708. The PCIe communication element then sends the request in the PCIe protocol (or other suitable communication protocol) to the host (e.g., host processing unit 106) for performance by the host memory (e.g., system memory 110).

At 712, the host sends a completion or completion with data in the PCIe protocol to the PCIe communication element. At 714, the PCIe communication element sends a completion or completion with data in the primary fabric protocol to the graphics device 114. This is then forwarded to the host I/O bridge 119 at 716. The host I/O bridge 119 translates the completion or completion with data into a response or completion in the compute protocol and transmits it to request/response handler 136 at 718. The response or completion is then sent to the compute engine 112 at 720.

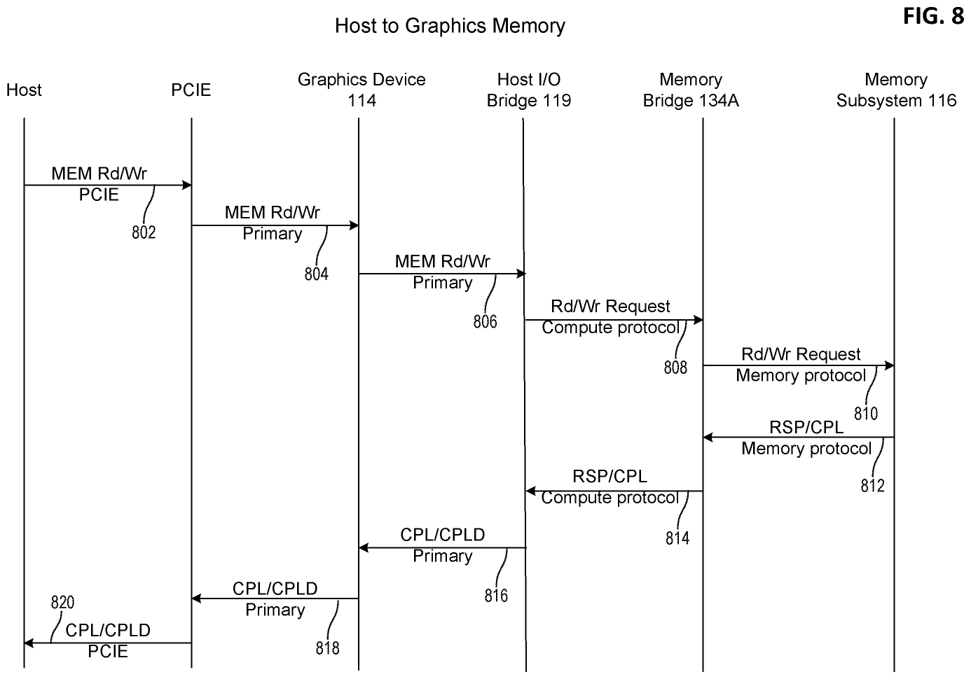

FIG. 8 illustrates a flow for a request from a host to graphics memory 108 in accordance with certain embodiments. At 802, a host sends a memory read or write request over the PCIe protocol (or other suitable communication protocol) to a PCIe communication element. The PCIe communication element then sends the memory read or write request in the primary fabric protocol to the graphics device 114. At 806, the memory read or write request is forwarded to the host I/O bridge 119. The host I/O bridge 119 converts the request to the compute protocol and then sends the request to memory bridge 134A at 808. The memory bridge 134A converts the request into the memory protocol and sends the request to the memory subsystem at 810.

At 812, the memory subsystem sends a response or completion in the memory protocol to the memory bridge 134A. The memory bridge may convert the response or completion into the compute protocol and send it to the host I/O bridge 119 at 814. The host I/O bridge converts the response or completion into a completion or completion with data in the primary fabric protocol and sends it to graphics device 114 at 816 which forwards the message to the PCIe communication element at 818. The completion or completion with data is then sent in the PCIe protocol to the host at 820.

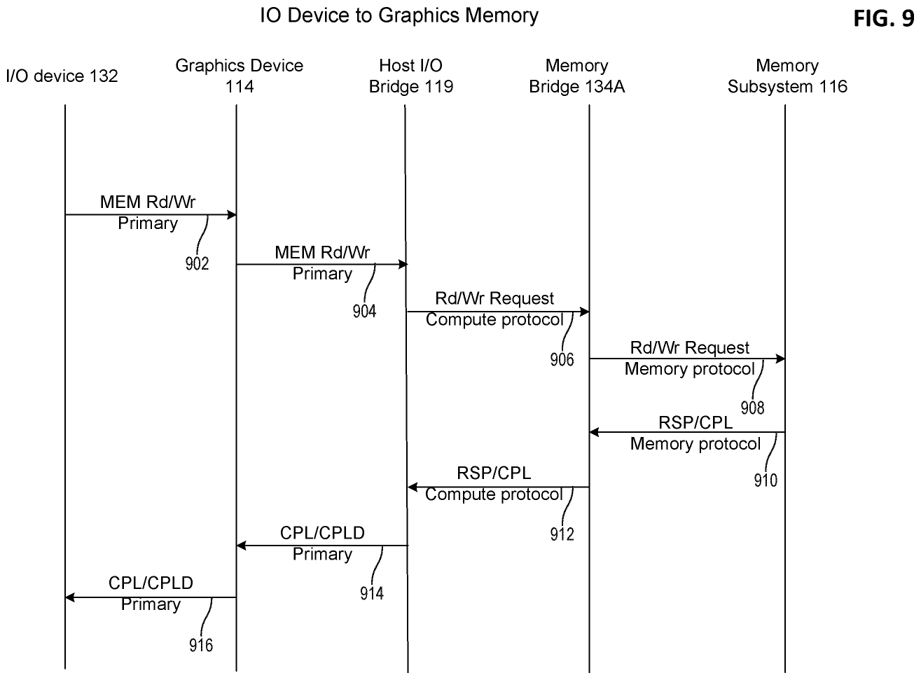

FIG. 9 illustrates a flow for a request from an input/output (I/O) device 132 to graphics memory 108 in accordance with certain embodiments. In some embodiments, and I/O device 132 may be removably coupled to the SoC 102. For example, the I/O device could be a Universal Serial Bus device or other suitable device.

At 902, a memory read or write request in the primary fabric is sent from an I/O device 132 to graphics device 114. At 904, the memory read or write request is forwarded to the host I/O bridge 119. The host I/O bridge 119 converts the request to the compute protocol and sends the request to the memory bridge 134A at 906. The memory bridge 134A converts the request into the memory protocol and sends the request to the memory subsystem 116.

The memory subsystem 116 may send a response or completion in the memory protocol to memory bridge 134A at 910. The memory bridge 134A then sends the response or completion in the compute protocol to host I/O bridge 119 at 912. At 914, the bridge 119 converts the response or completion into a completion or completion with data in the primary fabric protocol and sends it to the graphics device 114. At 916, the completion or completion with data is sent to the I/O device 132.

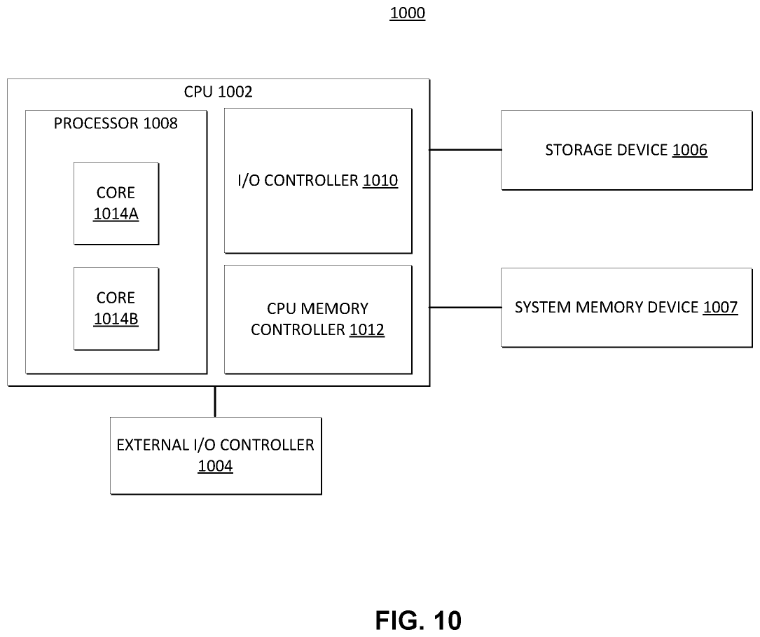

FIGS. 10-12 depict example systems in which various embodiments described herein may be implemented. For example, any of the systems depicted (or one or more components thereof) may be included within system 100. For example, CPU 1002 or processor 1110 may represent a host processing unit 106 that may be coupled to SoC 102 and system memory device 1007 may represent an example of system memory 110 (or graphics memory 108). As another example, GPU 1215 and/or video codec 1220 could be included within SoC 102.

FIG. 10 illustrates components of a computer system 1000 in accordance with certain embodiments. System 1000 includes a central processing unit (CPU) 1002 coupled to an external input/output (I/O) controller 1004, a storage device 1006 such as a solid state drive (SSD) or a dual inline memory module (DIMM), and system memory device 1007. During operation, data may be transferred between a storage device 1006 and/or system memory device 1007 and the CPU 1002. In various embodiments, particular memory access operations (e.g., read and write operations) involving a storage device 1006 or system memory device 1007 may be issued by an operating system and/or other software applications executed by processor 1008.

CPU 1002 comprises a processor 1008, such as a microprocessor, an embedded processor, a digital signal processor (DSP), a network processor, a handheld processor, an application processor, a co-processor, an SOC, or other device to execute code (e.g., software instructions). Processor 1008, in the depicted embodiment, includes two processing elements (cores 1014A and 1014B in the depicted embodiment), which may include asymmetric processing elements or symmetric processing elements. However, a processor may include any number of processing elements that may be symmetric or asymmetric. CPU 1002 may be referred to herein as a host computing device (though a host computing device may be any suitable computing device operable to issue memory access commands to a storage device 1006).

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core 1014 (e.g., 1014A or 1014B) may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

In various embodiments, the processing elements may also include one or more arithmetic logic units (ALUs), floating point units (FPUs), caches, instruction pipelines, interrupt handling hardware, registers, or other hardware to facilitate the operations of the processing elements.

In some embodiments, processor 1008 may comprise a processor unit, such as a processor core, graphics processing unit, hardware accelerator, field programmable gate array, neural network processing unit, artificial intelligence processing unit, inference engine, data processing unit, or infrastructure processing unit.

I/O controller 1010 is an integrated I/O controller that includes logic for communicating data between CPU 1002 and I/O devices. In other embodiments, the I/O controller 1010 may be on a different chip from the CPU 1002. I/O devices may refer to any suitable devices capable of transferring data to and/or receiving data from an electronic system, such as CPU 1002. For example, an I/O device may comprise an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input device such as a monitor, printer, mouse, keyboard, or scanner; or other suitable device. In a particular embodiment, an I/O device may comprise a storage device 1006 coupled to the CPU 1002 through I/O controller 1010.

An I/O device may communicate with the I/O controller 1010 of the CPU 1002 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In particular embodiments, I/O controller 1010 and an associated I/O device may communicate data and commands in accordance with a logical device interface specification such as Non-Volatile Memory Express (NVMe) (e.g., as described by one or more of the specifications available at www.nvmexpress.org/specifications/) or Advanced Host Controller Interface (AHCI) (e.g., as described by one or more AHCI specifications such as Serial ATA AHCI. Specification, Rev. 1.3.1 available at http://www.intel.com/content/www/us/en/io/serial-ata/serial-ata-ahci-spec-revl-3-1.html). In various embodiments, I/O devices coupled to the I/O controller 1010 may be located off-chip (e.g., not on the same chip as CPU 1002) or may be integrated on the same chip as the CPU 1002.

CPU memory controller 1012 is an integrated memory controller that controls the flow of data going to and from one or more system memory devices 1007. CPU memory controller 1012 may include logic operable to read from a system memory device 1007, write to a system memory device 1007, or to request other operations from a system memory device 1007. In various embodiments, CPU memory controller 1012 may receive write requests from cores 1014 and/or I/O controller 1010 and may provide data specified in these requests to a system memory device 1007 for storage therein. CPU memory controller 1012 may also read data from a system memory device 1007 and provide the read data to I/O controller 1010 or a core 1014. During operation, CPU memory controller 1012 may issue commands including one or more addresses of the system memory device 1007 in order to read data from or write data to memory (or to perform other operations). In some embodiments, CPU memory controller 1012 may be implemented on the same chip as CPU 1002, whereas in other embodiments, CPU memory controller 1012 may be implemented on a different chip than that of CPU 1002. I/O controller 1010 may perform similar operations with respect to one or more storage devices 1006.

The CPU 1002 may also be coupled to one or more other I/O devices through external I/O controller 1004. In a particular embodiment, external I/O controller 1004 may couple a storage device 1006 to the CPU 1002. External I/O controller 1004 may include logic to manage the flow of data between one or more CPUs 1002 and I/O devices. In particular embodiments, external I/O controller 1004 is located on a motherboard along with the CPU 1002. The external I/O controller 1004 may exchange information with components of CPU 1002 using point-to-point or other interfaces.

A system memory device 1007 may store any suitable data, such as data used by processor 1008 to provide the functionality of computer system 1000. For example, data associated with programs that are executed or files accessed by cores 1014 may be stored in system memory device 1007. Thus, a system memory device 1007 may include a system memory that stores data and/or sequences of instructions that are executed or otherwise used by the cores 1014. In various embodiments, a system memory device 1007 may store temporary data, persistent data (e.g., a user's files or instruction sequences) that maintains its state even after power to the system memory device 1007 is removed, or a combination thereof. A system memory device 1007 may be dedicated to a particular CPU 1002 or shared with other devices (e.g., one or more other processors or other devices) of computer system 1000.

In various embodiments, a system memory device 1007 may include a memory comprising any number of memory partitions, a memory device controller, and other supporting logic (not shown). A memory partition may include non-volatile memory and/or volatile memory.

Non-volatile memory is a storage medium that does not require power to maintain the state of data stored by the medium, thus non-volatile memory may have a determinate state even if power is interrupted to the device housing the memory. Nonlimiting examples of nonvolatile memory may include any or a combination of: 3D crosspoint memory, phase change memory (e.g., memory that uses a chalcogenide glass phase change material in the memory cells), ferroelectric memory, silicon-oxide-nitride-oxide-silicon (SONOS) memory, polymer memory (e.g., ferroelectric polymer memory), ferroelectric transistor random access memory (Fe-TRAM) ovonic memory, anti-ferroelectric memory, nanowire memory, electrically erasable programmable read-only memory (EEPROM), a memristor, single or multi-level phase change memory (PCM), Spin Hall Effect Magnetic RAM (SHE-MRAM), and Spin Transfer Torque Magnetic RAM (STTRAM), a resistive memory, magnetoresistive random access memory (MRAM) memory that incorporates memristor technology, resistive memory including the metal oxide base, the oxygen vacancy base and the conductive bridge Random Access Memory (CB-RAM), a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory.

Volatile memory is a storage medium that requires power to maintain the state of data stored by the medium (thus volatile memory is memory whose state (and therefore the data stored on it) is indeterminate if power is interrupted to the device housing the memory). Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (double data rate version 3, original release by JEDEC (Joint Electronic Device Engineering Council) on Jun. 27, 2007, currently on release 21), DDR4 (DDR version 4, JESD79-4 initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5, originally published by JEDEC in January 2020, HBM2 (HBM version 2), originally published by JEDEC in January 2020, or others or combinations of memory technologies, and technologies based on derivatives or extensions of such specifications.

A storage device 1006 may store any suitable data, such as data used by processor 1008 to provide functionality of computer system 1000. For example, data associated with programs that are executed or files accessed by cores 1014A and 1014B may be stored in storage device 1006. Thus, in some embodiments, a storage device 1006 may store data and/or sequences of instructions that are executed or otherwise used by the cores 1014A and 1014B. In various embodiments, a storage device 1006 may store persistent data (e.g., a user's files or software application code) that maintains its state even after power to the storage device 1006 is removed. A storage device 1006 may be dedicated to CPU 1002 or shared with other devices (e.g., another CPU or other device) of computer system 1000.

In various embodiments, storage device 1006 may comprise a disk drive (e.g., a solid state drive); a memory card; a Universal Serial Bus (USB) drive; a Dual In-line Memory Module (DIMM), such as a Non-Volatile DIMM (NVDIMM); storage integrated within a device such as a smartphone, camera, or media player; or other suitable mass storage device.

In a particular embodiment, a semiconductor chip may be embodied in a semiconductor package. In various embodiments, a semiconductor package may comprise a casing comprising one or more semiconductor chips (also referred to as dies). A package may also comprise contact pins or leads used to connect to external circuits.

In some embodiments, all or some of the elements of system 1000 are resident on (or coupled to) the same circuit board (e.g., a motherboard). In various embodiments, any suitable partitioning between the elements may exist. For example, the elements depicted in CPU 1002 may be located on a single die (e.g., on-chip) or package or any of the elements of CPU 1002 may be located off-chip or off-package. Similarly, the elements depicted in storage device 1006 may be located on a single chip or on multiple chips. In various embodiments, a storage device 1006 and a computing host (e.g., CPU 1002) may be located on the same circuit board or on the same device and in other embodiments the storage device 1006 and the computing host may be located on different circuit boards or devices.

The components of system 1000 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, and a Gunning transceiver logic (GTL) bus. In various embodiments, an integrated I/O subsystem includes point-to-point multiplexing logic between various components of system 1000, such as cores 1014, one or more CPU memory controllers 1012, I/O controller 1010, integrated I/O devices, direct memory access (DMA) logic (not shown), etc. In various embodiments, components of computer system 1000 may be coupled together through one or more networks comprising any number of intervening network nodes, such as routers, switches, or other computing devices. For example, a computing host (e.g., CPU 1002) and the storage device 1006 may be communicably coupled through a network.

Although not depicted, system 1000 may use a battery and/or power supply outlet connector and associated system to receive power, a display to output data provided by CPU 1002, or a network interface allowing the CPU 1002 to communicate over a network. In various embodiments, the battery, power supply outlet connector, display, and/or network interface may be communicatively coupled to CPU 1002. Other sources of power can be used such as renewable energy (e.g., solar power or motion based power).

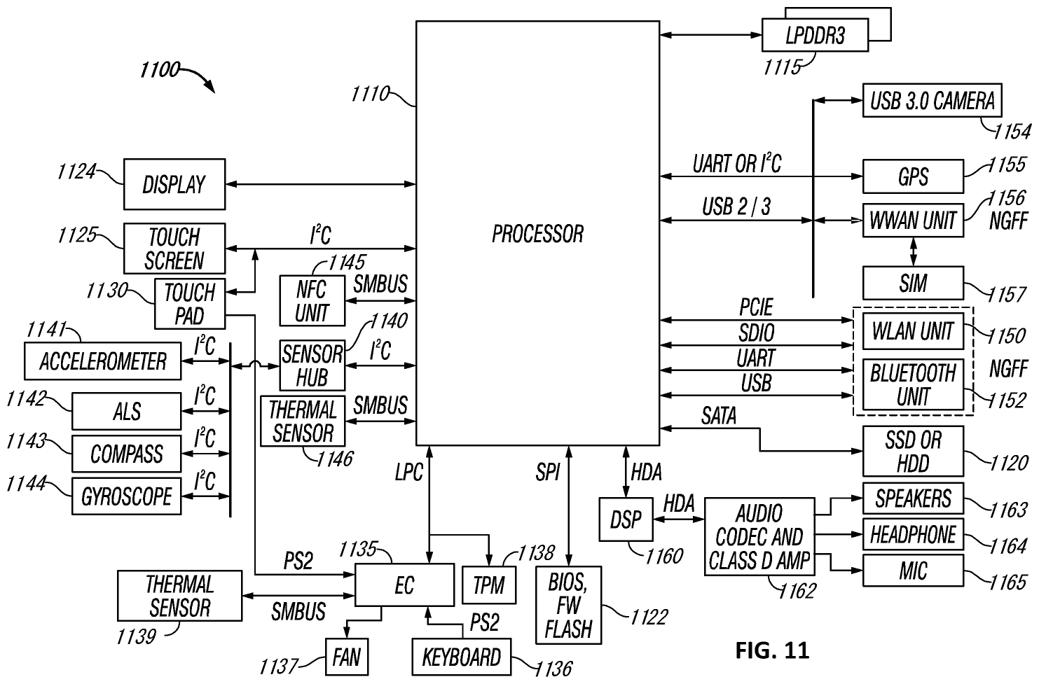

Referring now to FIG. 11, a block diagram of components present in a computer system that may function as either a host device or a peripheral device (or which may include both a host device and one or more peripheral devices) in accordance with certain embodiments is described. As shown in FIG. 11, system 1100 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 11 is intended to show a high level view of many components of the computer system. However, it is to be understood that some of the components shown may be omitted, additional components may be present, and different arrangement of the components shown may occur in other implementations. As a result, the disclosure described above may be implemented in any portion of one or more of the interconnects illustrated or described below.

As seen in FIG. 11, a processor 1110, in one embodiment, includes a microprocessor, multi-core processor, multithreaded processor, an ultra-low voltage processor, an embedded processor, or other known processing element. In the illustrated implementation, processor 1110 acts as a main processing unit and central hub for communication with many of the various components of the system 1100. As one example, processor 1110 is implemented as a system on a chip (SoC). As a specific illustrative example, processor 1110 includes an Intel® Architecture Core™-based processor such as an i3, i5, i7 or another such processor available from Intel Corporation, Santa Clara, Calif. However, other low power processors such as those available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitecture implementation may vary, but the architectural function of the processor is usually consistent. Certain details regarding the architecture and operation of processor 1110 in one implementation will be discussed further below to provide an illustrative example.

Processor 1110, in one embodiment, communicates with a system memory 1115. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (QDP). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 1120 may also couple to processor 1110. In various embodiments, to enable a thinner and lighter system design as well as to improve system responsiveness, this mass storage may be implemented via a SSD. However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 11, a flash device 1122 may be coupled to processor 1110, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (I/O) devices may be present within system 1100. Specifically shown in the embodiment of FIG. 11 is a display 1124 which may be a high definition LCD or LED panel configured within a lid portion of the chassis. This display panel may also provide for a touch screen 1125, e.g., adapted externally over the display panel such that via a user's interaction with this touch screen, user inputs can be provided to the system to enable desired operations, e.g., with regard to the display of information, accessing of information and so forth. In one embodiment, display 1124 may be coupled to processor 1110 via a display interconnect that can be implemented as a high performance graphics interconnect. Touch screen 1125 may be coupled to processor 1110 via another interconnect, which in an embodiment can be an I2C interconnect. As further shown in FIG. 11, in addition to touch screen 1125, user input by way of touch can also occur via a touch pad 1130 which may be configured within the chassis and may also be coupled to the same I2C interconnect as touch screen 1125.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080p), be compatible with an embedded display port (eDP), and be a low power panel with panel self refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited I/O interference when using multi-touch.

For perceptual computing and other purposes, various sensors may be present within the system and may be coupled to processor 1110 in different manners. Certain inertial and environmental sensors may couple to processor 1110 through a sensor hub 1140, e.g., via an I2C interconnect. In the embodiment shown in FIG. 11, these sensors may include an accelerometer 1141, an ambient light sensor (ALS) 1142, a compass 1143 and a gyroscope 1144. Other environmental sensors may include one or more thermal sensors 1146 which in some embodiments couple to processor 1110 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example, with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

Also seen in FIG. 11, various peripheral devices may couple to processor 1110. In the embodiment shown, various components can be coupled through an embedded controller 1135. Such components can include a keyboard 1136 (e.g., coupled via a PS2 interface), a fan 1137, and a thermal sensor 1139. In some embodiments, touch pad 1130 may also couple to EC 1135 via a PS2 interface. In addition, a security processor such as a trusted platform module (TPM) 1138 in accordance with the Trusted Computing Group (TCG) TPM Specification Version 1.2, dated Oct. 2, 2003, may also couple to processor 1110 via this LPC interconnect. However, understand the scope of the present disclosure is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with the Universal Serial Bus (USB) Revision 3.2 Specification (September 2017), with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 1100 can communicate with external devices in a variety of manners, including wirelessly. In the embodiment shown in FIG. 11, various wireless modules, each of which can correspond to a radio configured for a particular wireless communication protocol, are present. One manner for wireless communication in a short range such as a near field may be via a near field communication (NFC) unit 1145 which may communicate, in one embodiment with processor 1110 via an SMBus. Note that via this NFC unit 1145, devices in close proximity to each other can communicate. For example, a user can enable system 1100 to communicate with another portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 11, additional wireless units can include other short range wireless engines including a WLAN unit 1150 and a Bluetooth unit 1152. Using WLAN unit 1150, Wi-Fi™ communications in accordance with a given Institute of Electrical and Electronics Engineers (IEEE) 1102.11 standard can be realized, while via Bluetooth unit 1152, short range communications via a Bluetooth protocol can occur. These units may communicate with processor 1110 via, e.g., a USB link or a universal asynchronous receiver transmitter (UART) link. Or these units may couple to processor 1110 via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 1156 which in turn may couple to a subscriber identity module (SIM) 1157. In addition, to enable receipt and use of location information, a GPS module 1155 may also be present. Note that in the embodiment shown in FIG. 11, WWAN unit 1156 and an integrated capture device such as a camera module 1154 may communicate via a given USB protocol such as a USB 2.0 or 3.0 link, or a UART or I2C protocol. Again, the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 1160, which may couple to processor 1110 via a high definition audio (HDA) link. Similarly, DSP 1160 may communicate with an integrated coder/decoder (CODEC) and amplifier 1162 that in turn may couple to output speakers 1163 which may be implemented within the chassis. Similarly, amplifier and CODEC 1162 can be coupled to receive audio inputs from a microphone 1165 which in an embodiment can be implemented via dual array microphones (such as a digital microphone array) to provide for high quality audio inputs to enable voice-activated control of various operations within the system. Note also that audio outputs can be provided from amplifier/CODEC 1162 to a headphone jack 1164. Although shown with these particular components in the embodiment of FIG. 11, understand the scope of the present disclosure is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 1110 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

Power control in the processor can lead to enhanced power savings. For example, power can be dynamically allocated between cores, individual cores can change frequency/voltage, and multiple deep low power states can be provided to enable very low power consumption. In addition, dynamic control of the cores or independent core portions can provide for reduced power consumption by powering off components when they are not being used.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TxT), and Intel® Manageability Engine Technology along with secure user interfaces such as a secure keyboard and display.

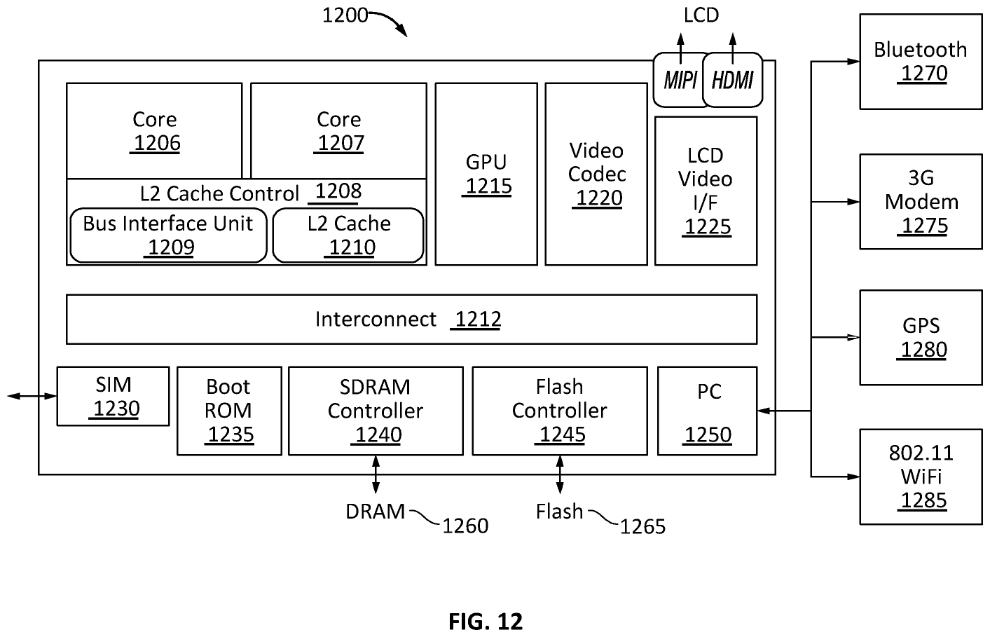

Turning next to FIG. 12, another block diagram for an example computing system that may serve as a host device or peripheral device (or may include both a host device and one or more peripheral devices) in accordance with certain embodiments is shown. As a specific illustrative example, SoC 1200 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SoC 1200 includes 2 cores-1206 and 1207. Similar to the discussion above, cores 1206 and 1207 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1206 and 1207 are coupled to cache control 1208 that is associated with bus interface unit 1209 and L2 cache 1210 to communicate with other parts of system 1200. Interconnect 1212 includes an on-chip interconnect, such as an IOSF, AMBA, or other interconnect discussed above, which potentially implements one or more aspects of the described disclosure.

Interconnect 1212 provides communication channels to the other components, such as a Subscriber Identity Module (SIM) 1230 to interface with a SIM card, a boot rom 1235 to hold boot code for execution by cores 1206 and 1207 to initialize and boot SoC 1200, a SDRAM controller 1240 to interface with external memory (e.g. DRAM 1260), a flash controller 1245 to interface with non-volatile memory (e.g. Flash 1265), a peripheral control 1250 (e.g. Serial Peripheral Interface) to interface with peripherals, video codecs 1220 and Video interface 1225 to display and receive input (e.g. touch enabled input), GPU 1215 to perform graphics related computations, etc. Any of these interfaces may incorporate aspects of the disclosure described herein.

In addition, the system illustrates peripherals for communication, such as a Bluetooth module 1270, 3G modem 1275, GPS 1280, and WiFi 1285. Note as stated above, a UE includes a radio for communication. As a result, these peripheral communication modules are not all required. However, in a UE some form of a radio for external communication is to be included.

Although the drawings depict particular computer systems, the concepts of various embodiments are applicable to any suitable integrated circuits and other logic devices. Examples of devices in which teachings of the present disclosure may be used include desktop computer systems, server computer systems, storage systems, handheld devices, tablets, other thin notebooks, systems on a chip (SOC) devices, and embedded applications. Some examples of handheld devices include cellular phones, digital cameras, media players, personal digital assistants (PDAs), and handheld PCs. Embedded applications may include, e.g., a microcontroller, a digital signal processor (DSP), an SOC, a network computer (NetPC), a set-top box, a network hub, a wide area network (WAN) switch, or any other system that can perform the functions and operations taught below. Various embodiments of the present disclosure may be used in any suitable computing environment, such as a personal computing device, a server, a mainframe, a cloud computing service provider infrastructure, a datacenter, a communications service provider infrastructure (e.g., one or more portions of an Evolved Packet Core), or other environment comprising a group of computing devices.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HIDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

A module as used herein or as depicted in the FIGs. refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Logic may be used to implement any of the flows described or functionality of the various components of the FIGs., subcomponents thereof, or other entity or component described herein. “Logic” may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a storage device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in storage devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash storage devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Example 1 includes a system comprising a discrete graphics system-on-chip (SoC) to couple to a host processor unit, the SoC comprising a fabric comprising a handler circuitry to decode a request from a compute engine, the handler circuitry to route the request towards one of a graphics memory coupled to the SoC, a host memory coupled to the host processor unit, or a sideband network of the SoC based at least in part on an opcode included in the request, the handler configured to decode the opcode from a set of opcodes for use in requests by the compute engine, wherein the set of opcodes include opcodes corresponding to a first write request type and a first read request type, wherein requests of the first write request type and the first read request type are routed to either the host memory or the graphics memory; and a second write request type and a second read request type, wherein requests of the second write request type and the second request type are to be routed to the sideband network.

Example 2 includes the subject matter of Example 1, and wherein the set of opcodes includes an opcode corresponding to a third write request type, wherein requests of the third write request type are to be routed to either the host memory or the graphics memory, wherein the third write request type specifies a partial write request and the first write request type specifies a full write request.

Example 3 includes the subject matter of any of Examples 1 and 2, and wherein the set of opcodes is limited to the opcodes corresponding to the first, second, and third write request types and the first and second read request types.

Example 4 includes the subject matter of any of Examples 1-3, and wherein the fabric comprises a second handler circuitry to decode a second request from the compute engine, wherein the second handler is configured to route requests containing opcodes corresponding to the first write request type and second read request type only towards the graphics memory and not towards the host memory.

Example 5 includes the subject matter of any of Examples 1-4, and wherein the fabric comprises a first link coupled between the handler circuitry and a memory subsystem and a second link between the second handler circuitry and the memory subsystem, the memory subsystem to couple to the graphics memory.

Example 6 includes the subject matter of any of Examples 1-5, and wherein the fabric comprises a third link coupled between a bridge circuitry and the memory subsystem, wherein the bridge circuitry is to communicate read and write requests received from the host processing unit towards the graphics memory.

Example 7 includes the subject matter of any of Examples 1-6, and wherein the fabric further comprises a bridge circuitry coupled to the handler circuitry, the bridge circuitry to receive first requests of the first write request type and the first read request type from the handler circuitry and communicate the first requests towards the host processing unit.

Example 8 includes the subject matter of any of Examples 1-7, and wherein the bridge circuitry is to translate the first requests from a first protocol used by the compute engine to a second protocol used by a second fabric of the SoC.

Example 9 includes the subject matter of any of Examples 1-8, and wherein the bridge circuitry is to receive read and write requests from the host processing unit and send the read and write requests towards the graphics memory.

Example 10 includes the subject matter of any of Examples 1-9, and wherein the bridge circuitry is to receive a request from an input/output device removably coupled to the SoC and send the request towards the graphics memory.

Example 11 includes the subject matter of any of Examples 1-10, and wherein the fabric further comprises a second bridge circuitry coupled to the handler circuitry, the second bridge circuitry to receive second requests of the second write request type and the second read request type from the handler circuitry and communicate the second requests towards the sideband network.

Example 12 includes the subject matter of any of Examples 1-11, and wherein requests of the second write request type includes addresses of registers storing configuration data for agents of the SoC.

Example 13 includes the subject matter of any of Examples 1-12, and wherein the SoC further comprises the compute engine.

Example 14 includes the subject matter of any of Examples 1-13, and further including the graphics memory.

Example 15 includes the subject matter of any of Examples 1-14, and further including the host processor unit.

Example 16 includes the subject matter of any of Examples 1-15, and further including a battery communicatively coupled to the host processor unit, a display communicatively coupled to the host processor unit, or a network interface communicatively coupled to the host processor unit.

Example 17 includes an apparatus comprising a compute engine to perform rendering operations for a discrete graphics system-on-chip (SoC), the compute engine comprising circuitry to issue a first request for a graphics memory coupled to the SoC, the first request for the graphics memory comprising a first opcode corresponding to a write operation; issue a second request for the graphics memory coupled to the SoC, the second request for the graphics memory comprising a second opcode corresponding to a read operation; issue a first request for a host memory coupled to a host processing unit coupled to the SoC, the first request for the host memory comprising the first opcode; issue a second request for the host memory, the second request comprising the second opcode; issue a first request for a sideband network of the SoC, the first request for the sideband network comprising a third opcode corresponding to a write operation; and issue a second request for the sideband network of the SoC, the second request for the sideband network comprising a fourth opcode corresponding to a read operation.

Example 18 includes the subject matter of Example 17, and wherein the circuitry of the compute engine is to send the first and second requests for the graphics memory, first and second requests for the host memory, and first and second requests for the sideband network over a first link to a fabric of the SoC, and wherein the circuitry of the compute engine is to send a third request for the graphics memory over a second link to the fabric of the SoC that is dedicated to request for the graphics memory, the third request for the graphics memory comprising the first opcode.

Example 19 includes the subject matter of any of Examples 17 and 18, and wherein the circuitry of the compute engine is to issue an instruction with an opcode corresponding to a third write request type, wherein requests of the third write request type are to be routed to either the host memory or the graphics memory, wherein the third write request type specifies a partial write request and the first write request type specifies a full write request.

Example 20 includes the subject matter of any of Examples 17-19, and wherein a set of opcodes usable by the compute engine on a fabric of the SoC is limited to the opcodes corresponding to the first, second, and third write request types and the first and second read request types.

Example 21 includes the subject matter of any of Examples 17-20, and wherein a fabric of the SoC comprises a first handler circuitry to route requests containing opcodes corresponding to the first write request type and second read request type only towards the graphics memory and towards the host memory and a second handler circuitry to decode a second request from the compute engine, wherein the second handler circuitry is configured to route requests containing opcodes corresponding to the first write request type and second read request type only towards the graphics memory and not towards the host memory.

Example 22 includes the subject matter of any of Examples 17-21, and wherein the fabric comprises a first link coupled between the handler circuitry and a memory subsystem and a second link between the second handler circuitry and a memory subsystem, the memory subsystem to couple to the graphics memory.

Example 23 includes the subject matter of any of Examples 17-22, and wherein the fabric comprises a third link coupled between a bridge circuitry and the memory subsystem, wherein the bridge circuitry is to communicate read and write requests received from the host processing unit towards the graphics memory.

Example 24 includes the subject matter of any of Examples 17-23, and wherein the fabric further comprises a bridge circuitry coupled to the handler circuitry, the bridge circuitry to receive first requests of the first write request type and the first read request type from the handler circuitry and communicate the first requests towards the host processing unit.

Example 25 includes the subject matter of any of Examples 17-24, and wherein the bridge circuitry is to translate the first requests from a first protocol used by the compute engine to a second protocol used by a second fabric of the SoC.

Example 26 includes the subject matter of any of Examples 17-25, and wherein the bridge circuitry is to receive read and write requests from the host processing unit and send the read and write requests towards the graphics memory.

Example 27 includes the subject matter of any of Examples 17-26, and wherein the bridge circuitry is to receive a request from an input/output device removably coupled to the SoC and send the request towards the graphics memory.

Example 28 includes the subject matter of any of Examples 17-27, and wherein the fabric further comprises a second bridge circuitry coupled to the handler circuitry, the second bridge circuitry to receive second requests of the second write request type and the second read request type from the handler circuitry and communicate the second requests towards the sideband network.

Example 29 includes the subject matter of any of Examples 17-28, and wherein requests of the second write request type includes addresses of registers storing configuration data for agents of the SoC.

Example 30 includes the subject matter of any of Examples 17-29, and further including the graphics memory.

Example 31 includes the subject matter of any of Examples 17-30, and further including the host processor unit.

Example 32 includes the subject matter of any of Examples 17-31, and further including a battery communicatively coupled to the host processor unit, a display communicatively coupled to the host processor unit, or a network interface communicatively coupled to the host processor unit.

Example 33 includes a method comprising forming a discrete graphics system-on-chip (SoC) to couple to a host processor unit, the SoC comprising a fabric comprising a handler circuitry to decode a request from a compute engine, the handler circuitry to route the request towards one of a graphics memory coupled to the SoC, a host memory coupled to the host processor unit, or a sideband network of the SoC based at least in part on an opcode included in the request, the handler configured to decode the opcode from a set of opcodes for use in requests by the compute engine, wherein the set of opcodes include opcodes corresponding to a first write request type and a first read request type, wherein requests of the first write request type and the first read request type are routed to either the host memory or the graphics memory; and a second write request type and a second read request type, wherein requests of the second write request type and the second request type are to be routed to the sideband network.

Example 34 includes the subject matter of Example 33, and further including coupling the SoC to the graphics memory.

Example 35 includes the subject matter of any of Examples 33 and 34, and wherein the set of opcodes includes an opcode corresponding to a third write request type, wherein requests of the third write request type are to be routed to either the host memory or the graphics memory, wherein the third write request type specifies a partial write request and the first write request type specifies a full write request.

Example 36 includes the subject matter of any of Examples 33-35, and wherein the set of opcodes is limited to the opcodes corresponding to the first, second, and third write request types and the first and second read request types.

Example 37 includes the subject matter of any of Examples 33-36, and wherein the fabric comprises a second handler circuitry to decode a second request from the compute engine, wherein the second handler is configured to route requests containing opcodes corresponding to the first write request type and second read request type only towards the graphics memory and not towards the host memory.

Example 38 includes the subject matter of any of Examples 33-37, and wherein the fabric comprises a first link coupled between the handler circuitry and a memory subsystem and a second link between the second handler circuitry and the memory subsystem, the memory subsystem to couple to the graphics memory.

Example 39 includes the subject matter of any of Examples 33-38, and wherein the fabric comprises a third link coupled between a bridge circuitry and the memory subsystem, wherein the bridge circuitry is to communicate read and write requests received from the host processing unit towards the graphics memory.

Example 40 includes the subject matter of any of Examples 33-39, and wherein the fabric further comprises a bridge circuitry coupled to the handler circuitry, the bridge circuitry to receive first requests of the first write request type and the first read request type from the handler circuitry and communicate the first requests towards the host processing unit.

Example 41 includes the subject matter of any of Examples 33-40, and wherein the bridge circuitry is to translate the first requests from a first protocol used by the compute engine to a second protocol used by a second fabric of the SoC.

Example 42 includes the subject matter of any of Examples 33-41, and wherein the bridge circuitry is to receive read and write requests from the host processing unit and send the read and write requests towards the graphics memory.

Example 43 includes the subject matter of any of Examples 33-42, and wherein the bridge circuitry is to receive a request from an input/output device removably coupled to the SoC and send the request towards the graphics memory.

Example 44 includes the subject matter of any of Examples 33-43, and wherein the fabric further comprises a second bridge circuitry coupled to the handler circuitry, the second bridge circuitry to receive second requests of the second write request type and the second read request type from the handler circuitry and communicate the second requests towards the sideband network.

Example 45 includes the subject matter of any of Examples 33-44, and wherein requests of the second write request type includes addresses of registers storing configuration data for agents of the SoC.

Example 46 includes the subject matter of any of Examples 33-45, and wherein the SoC further comprises the compute engine.

Example 47 includes the subject matter of any of Examples 33-46, and further including coupling the graphics memory to the SoC.

Example 48 includes the subject matter of any of Examples 33-47, and further including coupling the host processor unit to the SoC.

Example 49 includes the subject matter of any of Examples 33-48, and further including communicatively coupling a battery, a display, or a network interface to the host processor unit.

What is claimed is:

1. A system comprising:
a discrete graphics system-on-chip (SoC) to couple to a host processor unit, the SoC comprising:
a fabric comprising a handler circuitry to decode a request from a compute engine, the handler circuitry to route the request towards one of a graphics memory coupled to the SoC, a host memory coupled to the host processor unit, or a sideband network of the SoC based at least in part on an opcode included in the request, the handler configured to decode the opcode from a set of opcodes for use in requests by the compute engine, wherein the set of opcodes include opcodes corresponding to:
a first write request type and a first read request type, wherein requests of the first write request type and the first read request type are routed to either the host memory or the graphics memory; and
a second write request type and a second read request type, wherein requests of the second write request type and the second request type are to be routed to the sideband network.

2. The system of claim 1, wherein the set of opcodes includes an opcode corresponding to a third write request type, wherein requests of the third write request type are to be routed to either the host memory or the graphics memory, wherein the third write request type specifies a partial write request and the first write request type specifies a full write request.

3. The system of claim 2, wherein the set of opcodes is limited to the opcodes corresponding to the first, second, and third write request types and the first and second read request types.

4. The system of claim 1, wherein the fabric comprises a second handler circuitry to decode a second request from the compute engine, wherein the second handler is configured to route requests containing opcodes corresponding to the first write request type and second read request type only towards the graphics memory and not towards the host memory.

5. The system of claim 4, wherein the fabric comprises a first link coupled between the handler circuitry and a memory subsystem and a second link between the second handler circuitry and the memory subsystem, the memory subsystem to couple to the graphics memory.

6. The system of claim 5, wherein the fabric comprises a third link coupled between a bridge circuitry and the memory subsystem, wherein the bridge circuitry is to communicate read and write requests received from the host processing unit towards the graphics memory.

7. The system of claim 1, wherein the fabric further comprises a bridge circuitry coupled to the handler circuitry, the bridge circuitry to receive first requests of the first write request type and the first read request type from the handler circuitry and communicate the first requests towards the host processing unit.

8. The system of claim 7, wherein the bridge circuitry is to translate the first requests from a first protocol used by the compute engine to a second protocol used by a second fabric of the SoC.

9. The system of claim 7, wherein the bridge circuitry is to receive read and write requests from the host processing unit and send the read and write requests towards the graphics memory.

10. The system of claim 7, wherein the bridge circuitry is to receive a request from an input/output device removably coupled to the SoC and send the request towards the graphics memory.

11. The system of claim 7, wherein the fabric further comprises a second bridge circuitry coupled to the handler circuitry, the second bridge circuitry to receive second requests of the second write request type and the second read request type from the handler circuitry and communicate the second requests towards the sideband network.

12. The system of claim 1, wherein requests of the second write request type includes addresses of registers storing configuration data for agents of the SoC.

13. The system of claim 1, wherein the SoC further comprises the compute engine.

14. The system of claim 1, further comprising the graphics memory.

15. The system of claim 1, further comprising the host processor unit.

16. The system of claim 15, further comprising a battery communicatively coupled to the host processor unit, a display communicatively coupled to the host processor unit, or a network interface communicatively coupled to the host processor unit.

17. An apparatus comprising:
a compute engine to perform rendering operations for a discrete graphics system-on-chip (SoC), the compute engine comprising circuitry to:
issue a first request for a graphics memory coupled to the SoC, the first request for the graphics memory comprising a first opcode corresponding to a write operation;
issue a second request for the graphics memory coupled to the SoC, the second request for the graphics memory comprising a second opcode corresponding to a read operation;
issue a first request for a host memory coupled to a host processing unit coupled to the SoC, the first request for the host memory comprising the first opcode;
issue a second request for the host memory, the second request comprising the second opcode;
issue a first request for a sideband network of the SoC, the first request for the sideband network comprising a third opcode corresponding to a write operation; and
issue a second request for the sideband network of the SoC, the second request for the sideband network comprising a fourth opcode corresponding to a read operation.

18. The apparatus of claim 17, wherein the circuitry of the compute engine is to send the first and second requests for the graphics memory, first and second requests for the host memory, and first and second requests for the sideband network over a first link to a fabric of the SoC, and wherein the circuitry of the compute engine is to send a third request for the graphics memory over a second link to the fabric of the SoC that is dedicated to request for the graphics memory, the third request for the graphics memory comprising the first opcode.

19. A method comprising:
forming a discrete graphics system-on-chip (SoC) to couple to a host processor unit, the SoC comprising:
a fabric comprising a handler circuitry to decode a request from a compute engine, the handler circuitry to route the request towards one of a graphics memory coupled to the SoC, a host memory coupled to the host processor unit, or a sideband network of the SoC based at least in part on an opcode included in the request, the handler configured to decode the opcode from a set of opcodes for use in requests by the compute engine, wherein the set of opcodes include opcodes corresponding to:
a first write request type and a first read request type, wherein requests of the first write request type and the first read request type are routed to either the host memory or the graphics memory; and
a second write request type and a second read request type, wherein requests of the second write request type and the second request type are to be routed to the sideband network.

20. The method of claim 19, further comprising coupling the SoC to the graphics memory.
